(19) United States
(12) Patent Application Publication
(10) Pub. No.: US 2007/0292464 A1
(43) Pub. Date: Dec. 20, 2007

(54) FIBERS AND SHEET-FORM TEXTILES PROVIDED WITH INSECT-REPELLENT FINISHES

(76) Inventors: Raymond Mathis, Duesseldorf (DE); Hans-Juergen Sladek, Krefeld (DE)

Correspondence Address: COGNIS CORPORATION;PATENT DEPARTMENT, 300 BROOKSIDE AVENUE, AMBLER, PA, 19002, US

(21) Appl. No.: 11/733,981

(22) Filed: Apr. 11, 2007

(30) Foreign Application Priority Data
Apr. 11, 2006 (DE) 10 2006 016 907.7

(51) Int. Cl. A01N 25/34; A01N 37/00; A01N 37/18; A01N 43/40; A01N 57/10; A01P 17/00

(52) U.S. Cl. 424/403; 514/106; 514/315; 514/529; 514/557; 514/617

(57) ABSTRACT

The present invention relates to fibers and sheet-form textiles which are characterized in that they are finished with mixtures of (a) microencapsulated insect repellents and (b) binders.

### RELATED APPLICATIONS

This application claims priority from DE 10 2006 016 907.7 filed Apr. 11, 2006, the entire contents of which are incorporated herein by reference.

### FIELD OF THE INVENTION

This invention relates generally to the treatment of textiles and, more particularly, to fibers and sheet-form textile materials which are finished to repel and protect against insect bites and to the use of special mixtures of substances for finishing textiles.

### BACKGROUND OF THE INVENTION

Malaria is a life-threatening infectious disease which is caused by single-cell organisms (plasmodiae) and transmitted through the anopheles mosquito which is indigenous to tropical and subtropical regions. The plasmodiae attack the red blood cells and multiply there. When the pathogens have matured, the blood cell bursts and releases new plasmodiae. The destruction of the red blood cells produces a fever. The new plasmodiae in turn attack red blood cells and again multiply there. This creates a cycle which, without medication, generally results in death through collapse of the circulation or pulmonary edema.

According to an estimate from the World Health Organisation (WHO), around 110 million people per year worldwide are affected by, and up to 2.7 million die from, the infection. This makes malaria the second most common disease in the world after tuberculosis. As a result of the growth in tourism, even tourists are increasingly falling victim, particularly to the dangerous Malaria tropica. There are now around 12,000 cases of malaria annually in Europe.

Malaria can always be successfully treated when it is detected early enough. Malaria prophylaxis is also possible (particularly using quinine compounds previously obtained from the bark of the China Tree) although the danger of resistance of the pathogens is increasing here, depending on the region involved. However, the best protection against malaria is not to be bitten in the first place. Since the anopheles mosquito—active at dusk and night—lives in and around damp areas and stagnant waters, the malaria risk is particularly high towards the end of the rainy period. In this period, small marshy pools in which the mosquito can lay her eggs are formed throughout the tropics. Thereafter the mosquitoes multiply explosively. However, it is not always possible to counter the risk of malaria attacks in the affected regions simply by moving to higher ground pending the dry period. The same also applies to other diseases transmitted solely by insect bites, such as for example the West Nile Virus or the Chikungunya disease known from La Réunion.

Rather there is a need for agents with which infections caused by insect bites can be reliably prevented or at least greatly reduced. Known insect repellents include sesquiterpenes, diethyl toluamide (DEET), Ethyl Butylacetylaminopropionate (IR 3535) and Hydroxyethyl Isobutyl Piperidine Carboxylate (Bayrepel) which is also part of the well-known “Autan” mixture. However, particularly effective repellents are insecticidal compounds from the group of pyrethroids which are very similar to the poison of the chrysanthemum from which they have also taken their name. Within this group, the compound permethrin 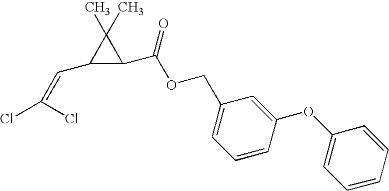
is known to be particularly effective.

A number of these repellents are directly applied to the skin, for example in the form of creams, lotions or sprays. However, the problem is that they are easily washed off or decomposed by perspiration and thus quickly lose their effectiveness and only products which are sufficiently dematologically compatible and toxicologically safe can be considered at all for this particular application. Accordingly, the particularly effective natural chrysanthemum extracts, such as pyrethrum for example, are generally ruled out for these reasons because they are hydrolyzed by water and decomposed by sunlight.

An alternative to topical application is to finish textiles with insect repellents. The repellents are generally applied by impregnation. In practice, however, this is far from efficient. When applied to panty hose for example, the quantity of active component is so small in view of the broad mesh material that the repellent effect per se is already inadequate. With closer-mesh textiles, i.e. slacks, shirts, T-shirts, and also, for example, awnings, mosquito and camouflage nets, the active component is very quickly washed out or is not available at all to repel insects because it is absorbed by the fibers. Another disadvantage is that direct application to the fibers or textiles involves large amounts of active components which imposes particular demands from the safety-at-work perspective.

Reference is made in this connection to U.S. Pat. No. 5,229,122 (Burroughs) which relates to mixtures of encapsulated and non-encapsulated pyrethroid active components which are used to treat wood, materials and buildings. EP 1359247 B1 (Cognis) discloses sheet-form textiles finished with microencapsulated cosmetic active components and binders.

Now, the complex problem addressed by the present invention was to apply insecticides and insect repellents, hereinafter noted collectively as insect repellents, to textiles in such a form that the repellents would actually be available to repel insects, i.e. would not be absorbed by the fibers and, on the other hand, would remain effective for a sufficiently long period, i.e. would withstand a sufficiently large number of washings without being washed out. At the same time, the form of application would ensure that the active components were protected against chemical or physical decomposition. Finally, the form of application would ensure that there would be a sufficient resistance to organic solvents, such as hexane for example, in which pyrethroids in particular are readily soluble.

### BRIEF DESCRIPTION OF THE INVENTION

The present invention relates to fibers and sheet-form textiles which are characterized in that they are finished with a mixture comprising:

(a) microencapsulated insect repellents (active components) and

(b) binders.

It has surprisingly been found that the effect of finishing fibers and textiles with microencapsulated insect repellents with the aid of binders is that, in practical tests, the substances offer excellent protection against insect bites. The microcapsules adhere firmly to the fibers so that, compared with the prior art, two things are achieved at the same time: first, the active component is actually available to repel insects and, second, the encapsulation is so robust that, although it withstands a large number of wash cycles, the active component is released purposefully and with delay. Another advantage is that the microcapsules are substantially equivalent in size to the diameter of the biting organs of the insects. This ensures that, in the event of direct contact between biting organ and textile, there is actually a sufficiently high probability of the capsules being affected and then releasing the active component in concentrated form, so that the insect is destroyed. The encapsulation also ensures that the sensitive active components are not degraded by physical or chemical processes so that they do not lose their effectiveness. Application of the capsules is easy and safe, particularly from the industrial hygiene perspective.

### DETAILED DESCRIPTION OF THE INVENTION

Insect Repellents

Insect repellents which may be used in the form of microcapsules for finishing fibers and textiles in accordance with the invention include, for example, sesquiterpenes, diethyltoluamide (DEET), Ethyl Butylacetylaminopropionate (IR3535), Hydroxyethyl Isobutyl Piperidine Carboxylate and, in particular, pyrethroids and mixtures thereof. Typical examples of pyrethroids are 5-benzyl-3-furylmethyl (+)-cis-(1R,3S,E) 2,2-dimethyl-3-(2-oxo-2,3,4,5-tetrahyfrothiophenylidenmethyl)cyclopropanecarboxylate, 6-chloropiperonyl 2,2-dimethyl-3-(2-methylpropenyl)cyclopropanecarboxylate, acrinathrin, allethrin, bifentrin, bioresmethrin, cismethrin, cyclethrin, cycloprothrin, cyfluthrin, cyhalothrin, cypermethrin, cyphenotrin, deltamethrin, dimethrin, empenthrin, esfenvalerat, fenfluthrin, fenpropathrin, fenvalerat, flucythrinat, flumethrin, fluvalinat, furethrin, halfenprox, imiprothrin, methyl cis/trans-3-(2,2-dichlorovinyl)-2,2-dimethylcyclopropane-1-carboxylate and, in particular, permethrin and mixtures thereof.

Microcapsules

“Microcapsules” or “nanocapsules” are understood by the expert to be spherical aggregates with a diameter of about 0.0001 to about 0.5 mm and preferably from 0.001 to 0.01 mm (i.e. from 1 to 10μ) which contain at least one solid or liquid core surrounded by at least one continuous membrane. More precisely, they are finely dispersed liquid or solid phases coated with film-forming polymers, in the production of which the polymers are deposited onto the material to be encapsulated after emulsification and coacervation or interfacial polymerization. In another process, molten waxes are absorbed in a matrix (“microsponge”) which, as microparticles, may be additionally coated with film-forming polymers. In a third process, particles are alternately coated with polelectrolytes having different charges (layer-by-layer process) The microscopically small capsules can be dried in the same way as powders. Besides single-core microcapsules, there are also multiple-core aggregates, also known as microspheres, which contain two or more cores distributed in the continuous membrane material. In addition, single core or multiple-core microcapsules may be surrounded by an additional second, third etc. membrane. The membrane may consist of natural, semisynthetic or synthetic materials. Natural membrane materials are, for example, gum arabic, agar agar, agarose, maltodextrins, alginic acid and salts thereof, for example sodium or calcium alginate, fats and fatty acids, cetyl alcohol, collagen, chitosan, lecithins, gelatin, albumin, shellac, polysaccharides, such as starch or dextran, polypeptides, protein hydrolyzates, sucrose and waxes. Semisynthetic membrane materials are inter alia chemically modified celluloses, more particularly cellulose esters and ethers, for example cellulose acetate, ethyl cellulose, hydroxypropyl cellulose, hydroxypropyl methyl cellulose and carboxymethyl cellulose, and starch derivatives, more particularly starch ethers and esters. Synthetic membrane materials are, for example, polymers, such as polyacrylates, polyamides, polyvinyl alcohol or polyvinyl pyrrolidone.

Examples of known microcapsules are the following commercial products (the membrane material is shown in brackets) Hallcrest Microcapsules (gelatin, gum arabic), Coletica Thalaspheres (maritime oollagen), Lipotec Millicapseln (alginic acid, agar agar), Induchem Unispheres (lactose, microcrystalline cellulose, hydroxypropylmethyl cellulose), Unicerin C30 (lactose, microcrystalline cellulose, hydroxypropylmethyl cellulose), Kobo Glycospheres (modified starch, fatty acid esters, phospholipids), Softspheres (modified agar agar), Kuhs Probiol Nanospheres (phospholipids), Primaspheres and Primasponges (chitosan, alginates) and Primasys (phospholipids).

Chitosan microcapsules and processes for their production are the subject of earlier patent applications filed by applicants [WO 01/01926, WO 01/01927, WO 01/01928, WO 01/01929]. Microcapsules with mean diameters of 0.0001 to 5, preferably 0.0005 to 0.05 and more particularly 0.001 to 0.01 mm, which consist of a membrane and a matrix containing the active components, may be obtained, for example, by
(a1) preparing a matrix from gel formers, chitosans and active components,
(a2) optionally dispersing the matrix in an oil phase and
(a3) treating the optionally dispersed matrix with aqueous solutions of anionic polymers and optionally removing the oil phase in the process or
(b1) preparing a matrix from gel formers, anionic polymers and active components,
(b2) optionally dispersing the matrix in an oil phase and
(b3) treating the optionally dispersed matrix with aqueous chitosan solutions and optionally removing the oil phase in the process or
(c1) preparing a matrix from anionic polymers and active components,
(c2) dispersing the matrix in an oil phase and
(c3) encapsulating the dispersed matrix with melaminelformaldehyde resins or maleic anhydride or
(d1) processing the active components with oil components in the presence of emulsifiers to form o/w emulsions,
(d2) treating the emulsions thus obtained with aqueous solutions of anionic polymers,
(d3) contacting the matrix thus obtained with aqueous chitosan solutions and
(d4) removing the encapsulated products thus obtained from the aqueous phase or
   coating the active component alternately with layers of differently charged polyelectrolytes (layer-by-layer technique).

Gel Formers

Preferred gel formers for the purposes of the invention are substances which are capable of forming gels in aqueous solution at temperatures above 40° C. Typical examples of such gel formers are heteropolysaccharides and proteins. Preferred thermogelling heteropoly-saccharides are agaroses which may be present in the form of the agar agar obtainable from red algae, even together with up to 30% by weight of non-gel-forming agaropectins. The principal constituent of agaroses are linear polysaccharides of D-galactose and 3,6-anhydro-L-galactose with alternate β-1,3- and β-1,4-glycosidic bonds. The heteropolysaccharides preferably have a molecular weight of 110,000 to 160,000 and are both odorless and tasteless. Suitable alternatives are pectins, xanthans (including xanthan gum) and mixtures thereof. Other preferred types are those which—in 1% by weight aqueous solution—still form gels that do not melt below 80° C. and solidify again above 40° C. Examples from the group of thermogelling proteins are the various gelatins.

Cationic Polymers

Suitable cationic polymers are, for example, cationic cellulose derivatives such as, for example, the quaternized hydroxyethyl cellulose obtainable from Amerchol under the name of Polymer JR 400®, cationic starch, copolymers of diallyl ammonium salts and acrylamides, quaternized vinyl pyrrolidone/vinyl imidazole polymers such as, for example, Luviquat® (BASF), condensation products of polyglycols and amines, quaternized collagen polypeptides such as, for example, Lauryldimonium Hydroxypropyl Hydrolyzed Collagen (Lamequat® L, Grünau), quaternized wheat poly-peptides, polyethyleneimine, cationic silicone polymers such as, for example, amodimethicone, copolymers of adipic acid and dimethylamino-hydroxypropyl diethylenetriamine (Cartaretine®, Sandoz), copolymers of acrylic acid with dimethyl diallyl ammonium chloride (Merquat® 550, Chemviron), polyaminopolyamides and crosslinked water-soluble polymers thereof, cationic chitin derivatives such as, for example, quaternized chitosan, optionally in microcrystalline distribution, condensation products of dihaloalkyls, for example dibromobutane, with bis-dialkylamines, for example bis-dimethylamino-1,3-propane, cationic guar gum such as, for example, Jaguar®CBS, Jaguar®C-17, Jaguar®C-16 of Celanese, quaternized ammonium salt polymers such as, for example, Mirapol® A-15, Mirapol® AD-1, Mirapol® AZ-1 of Miranol.

Chitosan is preferably used as the encapsulation material. Chitosans are biopolymers which belong to the group of hydrocolloids. Chemically, they are partly deacetylated chitins differing in their molecular weights which contain the following—idealized—monomer unit:

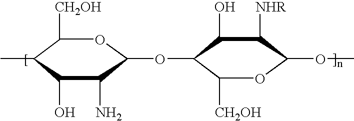

In contrast to most hydrocolloids, which are negatively charged at biological pH values, chitosans are cationic biopolymers under these conditions. The positively charged chitosans are capable of interacting with oppositely charged surfaces and are therefore used in cosmetic hair-care and body-care products and pharmaceutical preparations. Chitosans are produced from chitin, preferably from the shell residues of crustaceans which are available in large quantities as inexpensive raw materials. In a process described for the first time by Hackmann et al., the chitin is normally first deproteinized by addition of bases, demineralized by addition of mineral acids and, finally, deacetylated by addition of strong bases, the molecular weights being distributed over a broad spectrum. Preferred types are those which have an average molecular weight of 10,000 to 500,000 dalton or 800,000 to 1,200,000 dalton and/or a Brookfield viscosity (1% by weight in glycolic acid) below 5,000 mPas, a degree of deacetylation of 80 to 88% and an ash content of less than 0.3% by weight. In the interests of better solubility in water, the chitosans are generally used in the form of their salts, preferably as glycolates.

Oil Phase

Before formation of the membrane, the matrix may optionally be dispersed in an oil phase. Suitable oils for this purpose are, for example, Guerbet alcohols based on fatty alcohols containing 6 to 18 and preferably 8 to 10 carbon atoms, esters of linear C₆₋₂₂ fatty acids with linear C₆₋₂₂ fatty alcohols, esters of branched C₆₋₁₃ carboxylic acids with linear C₆₋₂₂ fatty alcohols such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆₋₂₂ fatty acids with branched alcohols, more particularly 2-ethyl hexanol, esters of hydroxycarboxylic acids with linear or branched C₆₋₂₂ fatty alcohols, more especially Dioctyl Malate, esters of linear and/or branched fatty acids with polyhydric alcohols (for example propylene glycol, dimer diol or trimer triol) and/or Guerbet alcohols, triglycerides based on C₆₋₁₀ fatty acids, liquid mono-/di-/triglyceride mixtures based on C₆₋₁₈ fatty acids, esters of C₆₋₂₂ fatty alcohols and/or Guerbet alcohols with aromatic carboxylic acids, more particularly benzoic acid, esters of C₂₋₁₂ dicarboxylic acids with linear or branched alcohols containing 1 to 22 carbon atoms or polyols containing 2 to 10 carbon atoms and 2 to 6 hydroxyl groups, vegetable oils, branched primary alcohols, substituted cyclohexanes, linear and branched C₆₋₂₂ fatty alcohol carbonates, Guerbet carbonates, esters of benzoic acid with linear and/or branched C₆₋₂₂ alcohols (for example Finsolv® TN), linear or branched, symmetrical or nonsymmetrical dialkyl ethers containing 6 to 22 carbon atoms per alkyl group, ring opening products of epoxidized fatty acid esters with polyols, silicone oils and/or aliphatic or naphthenic hydrocarbons, for example squalane, squalene or dialkyl cyclohexanes.

Anionic Polymers

The function of the anionic polymers is to form membranes with the chitosans. Preferred anionic polymers are salts of alginic acid. The alginic acid is a mixture of carboxyl-containing polysaccharides with the following idealized monomer unit:

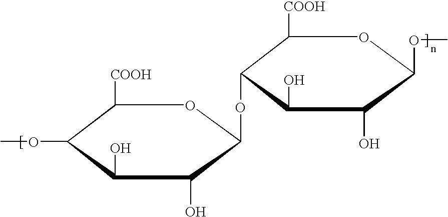

The average molecular weight of the alginic acids or the alginates is in the range from 150,000 to 250,000. Salts of alginic acid and complete and partial neutralization products thereof are understood in particular to be the alkali metal salts, preferably sodium alginate (“algin”), and the ammonium and alkaline earth metal salts. Mixed alginates, for example sodium/magnesium or sodium/calcium alginates, are particularly preferred. In an alternative embodiment of the invention, however, anionic chitosan derivatives, for example carboxylation and above all succinylation products are also suitable for this purpose. Alternatively, poly(methacrylates with average molecular weights of 5,000 to 50,000 dalton and the various carboxymethyl celluloses may also be used. Instead of the anionic polymers, anionic surfactants or low molecular weight inorganic salts, such as pyrophosphates for example, may also be used for forming the membrane.

If the anionic polymers are required to condense with melamine/formaldehyde resins, the use of polyvinyl methylether (PVM) is recommended. If polyvinyl methacrylate is used as the anionic polymer, the capsules can also be formed by addition of maleic anhydride. Capsules of the PVM/MA type are also preferred overall because they are extremely robust and resistant to solvents, such as hexane, and, with binders, preferably silicones, polyurethanes and ethylvinyl acetates, adhere particularly durably to the fibers and textiles, so that optimized protection is afforded.

Emulsifiers

Suitable emulsifiers are anionic, amphoteric, cationic or, preferably, nonionic surfactants from at least one of the following groups:
products of the addition of 2 to 30 mol ethylene oxide and/or 0 to 5 mol propylene oxide onto linear C₈₋₂₂ fatty alcohols, C₁₂₋₂₂ fatty acids and alkyl phenols containing 8 to 15 carbon atoms in the alkyl group and alkylamines containing 8 to 22 carbon atoms in the alkyl group;
alkyl and/or alkenyl oligoglycosides containing 8 to 22 carbon atoms in the alkyl group and ethoxylated analogs thereof;
addition products of 1 to 15 mol ethylene oxide onto castor oil and/or hydrogenated castor oil;
addition products of 15 to 60 mol ethylene oxide onto castor oil and/or hydrogenated castor oil;
partial esters of glycerol and/or sorbitan with unsaturated, linear or saturated, branched fatty acids containing 12 to 22 carbon atoms and/or hydroxycarboxylic acids containing 3 to 18 carbon atoms and addition products thereof with 1 to 30 mol ethylene oxide;
partial esters of polyglycerol (average degree of self-condensation 2 to 8), polyethylene glycol (molecular weight 400 to 5,000), trimethylolpropane, pentaerythrtol, sugar alcohols (for example sorbitol), alkyl glucosides (for example methyl glucoside, butyl glucoside, lauryl glucoside) and polyglucosides (for example cellulose) with saturated and/or unsaturated, linear or branched fatty acids containing 12 to 22 carbon atoms and/or hydroxycarboxylic acids containing 3 to 18 carbon atoms and addition products thereof with 1 to 30 mol ethylene oxide;
mixed esters of pentaerythritol, fatty acids, citric acid and fatty alcohol and/or mixed esters of fatty acids containing 6 to 22 carbon atoms, methyl glucose and polyols, preferably glycerol or polyglycerol;
mono, di- and trialkyl phosphates and mono-, di- and/or tri-PEG-alkyl phosphates and salts thereof;
wool wax alcohols;
polysiloxane/polyalkyl/polyether copolymers and corresponding derivatives;
block copolymers, for example Polyethyleneglycol-30 Dipolyhydroxystearate;
polymer emulsifiers, for example Pemulen types (TR-1), TR-2) from Goodrich;
polyalkylene glycols,
glycerol carbonate,
aliphatic fatty acids containing 12 to 22 carbon atoms, such as for example palmitic acid, stearic acid or behenic acid, and dicarboxylic acids containing 12 to 22 carbon atoms, such as for example azelaic acid or sebacic acid, and
betaines, such as N-alkyl-N,N-dimethylammonium glycinates, for example cocoalkyl dimethylammonium glycinate, N-acylaminopropyl-N,N-dimethylammonium glycinates, for example cocoacylaminopropyl dimethylammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate.
   Production Process for Microcapsules

To produce the microcapsules, a 1 to 10 and preferably 2 to 5% by weight aqueous solution of the gel former, preferably agar, is normally prepared and heated under reflux. A second aqueous solution containing the cationic polymer, preferably chtiosan, in quantities of 0.1 to 2 and preferably 0.25 to 0.5% by weight and the active substances in quantities of 0.1 to 25 and more particularly 0.25 to 10% by weight is added in the boiling heat, preferably at 80 to 100° C.; this mixture is called the matrix. Accordingly, the charging of the microcapsules with active substances may also comprise 0.1 to 25% by weight, based on the weight of the capsules. If desired, water-insoluble constituents, for example inorganic pigments, may be added at this stage to adjust viscosity, generally in the form of aqueous or aqueous/alcoholic dispersions. In addition, to emulsify or disperse the active substances, it can be useful to add emulsifiers and/or solubilizers to the matrix. After its preparation from gel former, cationic polymer and active substances, the matrix may optionally be very finely dispersed in an oil phase with intensive shearing in order to produce small particles in the subsequent encapsulation process. It has proved to be particularly advantageous in this regard to heat the matrix to temperatures in the range from 40 to 60° C. while the oil phase is cooled to 10 to 20° C. The actual encapsulation, i.e. formation of the membrane by contacting the cationic polymer in the matrix with the anionic polymers, takes place in the last, again compulsory step. To this end, it is advisable to wash the matrix optionally dispersed in the oil phase with an aqueous ca. 1 to 50 and preferably 10 to 15% by weight aqueous solution of the anionic polymer and, if necessary, to remove the oil phase either at the same time or afterwards. The resulting aqueous preparations generally have a microcapsule content of 1 to 10% by weight. In some cases, it can be of advantage for the solution of the polymers to contain other ingredients, for example emulsifiers or preservatives. After filtration, microcapsules with a mean diameter of preferably about 0.01 to 1 mm are obtained. It is advisable to sieve the capsules to ensure a uniform size distribution. The microcapsules thus obtained may have any shape within production-related limits, but are preferably substantially spherical. Alternatively, the anionic polymers may also be used for the preparation of the matrix and encapsulation may be carried out with the cationic polymers, especially the chitosans. Alternatively, encapsulation may be carried out using only cationic polymers and utilizing their property of coagulating at pH values above the pKs value.

In a second alternative process, the active components are mixed with the anionic polymers and the matrix thus obtained is dispersed in an oil component. After addition of melamine/formaldehyde resin, the dispersion is encapsulated. Alternatively, the active components may even be dispersed in the oil phase and the anionic polymers subsequently added before encapsulation is carried out.

Another alternative process for the production of the microcapsules according to the invention comprises initially preparing an o/w emulsion which, besides the oil component, water and the active components, contains an effective quantity of emulsifier. To form the matrix, a suitable quantity of an aqueous anionic polymer solution is added to this preparation with vigorous stirring. The membrane is formed by addition of the chitosan solution. The entire process preferably takes place at a mildly acidic pH of 3 to 4. If necessary, the pH is adjusted by addition of mineral acid. After formation of the membrane, the pH is increased to a value of 5 to 6, for example by addition of triethanolamine or another base. This results in an increase in viscosity which can be supported by addition of other thickeners such as, for example, polysaccharides, more particularly xanthan gum, guar gum, agar, alginates and tyloses, carboxymethyl cellulose and hydroxyethyl cellulose, relatively high molecular weight polyethylene glycol mono and diesters of fatty acids, polyacrylates, polyacrylamides and the like. Finally, the microcapsules are separated from the aqueous phase, for example by decantation, filtration or centrifuging.

In another alternative process, the capsules are formed by droplet formation and stabilization with a vinyl methylether/maleic anhydride copolymer, followed by crosslinking with a melamine/formaldehyde resin. Corresponding processes are known from the prior art, for example from DE 3512565 A1 (BASF) and U.S. Pat. No. 4,089,802 (NRC Corp.).

In a final alternative process, the microcapsules are formed around a preferably solid, for example crystalline, core by coating this core in layers with oppositely charged polyelectrolytes, cf. European patent EP 1064088 B1 (Max-Planck Gesellschaft).

Binders

The polymeric, film-forming binders suitable for the purposes of the invention may be selected from the group consisting of

polyurethanes,

polyethyl vinyl acetates,

polymeric melamine compounds,

polymeric glyoxal compounds,

polymeric silicone compounds

epichlorohydrin-crosslinked polyamidoamines,

poly(meth)acrylates and

polymeric fluorocarbons.

Polyurethanes and Polyvinyl Acetates

Suitable polyurethanes (PU) and polyethyl vinyl acetates (EVA) are the commercially available products from the Stabiflex® and Stabicryl® series marketed by Cognis Deutschland GmbH & Co. KG.

Polymeric Melamine Compounds

Melamine (synonym: 2,4,6-triamino-1,3,5-triazine) is normally formed by trimerization of dicyanodiamide or by cyclization of urea with elimination of carbon dioxide and ammonia. Melamines in the context of the invention are understood to be oligomeric or polymeric condensation products of melamine with formaldehyde, urea, phenol or mixtures thereof.

Polymeric Glyoxal Compounds

Glyoxal (synonym: oxaldehyde, ethanedial) is formed in the vapor-phase oxidation of ethylene glycol with air in the presence of silver catalysts. Glyoxals in the context of the present invention are understood to be the self-condensation products of glyoxal (“polyglyoxals”).

Polymeric Silicone Compounds

Suitable silicone compounds are, for example, dimethyl polysiloxanes, methylphenyl polysiloxanes, cyclic silicones and amino-, fatty acid-, alcohol-, polyether-, epoxy-, fluorine-, glycoside- and/or alkyl-modified silicone compounds which may be both liquid and resin-like at room temperature. Other suitable silicone compounds are simethicones which are mixtures of dimethicones with an average chain length of 200 to 300 dimethylsiloxane units and hydrogenated silicates. The use of aminosiloxanes, for example Cognis 3001 from Cognis Deutschland GmbH & Co. KG, is particularly preferred. Their further crosslinking with H-siloxanes, for example Cognis 3002 from Cognis Deutschland GmbH & Co. KG, can further enhancer their performance as binders.

Epichlorohydrin-Crosslinked Polyamidoamines

Epichlorohydrin-crosslinked polyamidoamines, which are also known as “fibrabones” or “wet strength resins”, are sufficiently well-known from textile and paper technology. They are preferably produced by two methods:
i) polyaminoamides are (a) initially reacted with a quantity of 5 to 30 mol-%, based on the nitrogen available for quaternization, of a quaternizing agent and (b) the resulting quaternized polyaminoamides are then crosslinked with a molar quantity of epichlorohydrin corresponding to the content of non-quaternized nitrogen, or
ii) polyaminoamides are (a) initially reacted at 10 to 35° C. with a quantity of 5 to 40 mol-%, based on the nitrogen available for crosslinking, of epichlorohydrin and (b) the intermediate product is adjusted to a pH of 8 to 11 and crosslinked at 20 to 45° C. with more epichlorohydrin so that the overall molar ratio is 90 to 125 mol-%, based on the nitrogen available for crosslinking.

Poly(meth)acrylates

Poly(meth)acrylates are understood to be homo and co-polymerization products of acrylic acid, methacrylic acid and optionally esters thereof, particularly with lower alcohols, such as for example methanol, ethanol, isopropyl alcohol, the isomeric butanols, cyclohexanol and the like, which are obtained in known manner, for example by radical polymerization in UV light. The average molecular weight of the polymers is typically between 100 and 10,000, preferably between 200 and 5,000 and more particularly between 400 and 2,000 dalton.

The binders—expressed as active substance—are applied to the fibers in quantities of typically 0.5 to 15% by weight, preferably 1 to 10% by weight and more particularly 1 to 5% by weight.

Quantities Used

The ratio of microcapsules to binder may be from 90:10 to 10:90 and is preferably from 75:25 to 25:75 and more particularly from 70:30 to 30:70 parts by weight. Different forms of adhesion can be achieved according to the production process and the microcapsule-to-binder ratio. Where a smaller quantity of binder is used (for example, ratio by weight of microcapsules to binder >50:50), the microcapsules adhere to the fibrils in a single layer of binder, so that there is direct contact between the membrane and the surface of the skin during wear. It is clear that, with this form of adhesion (“carrier type”), the active component is released very quickly through mechanical friction. If, on the other hand, a larger quantity of binder is used (for example, ratio by weight of microcapsules to binder <50:50), it is generally sufficient not only to bind the microcapsules to the fibers, but also to envelop them or provide them with a coating (“igloo type”). Microcapsules of correspondingly finished fibers are not in direct contact with the skin surface during wear so that, although they are released in smaller quantities, they are active for a longer time.

Commercial Applications

The combinations of microencapsulated active components and binders are used for finishing fibers and all kinds of textile fabrics, i.e. both end products and semifinished products, during or even after the production process in order thus to improve protection against insect bites. The choice of the materials of which the fibers or textiles consist is very largely not critical. Suitable materials are any standard natural and synthetic materials and blends thereof, but especially cotton, polyamides, polyesters, viscose, polyamide/Lycra, cotton/Lycra and cotton/polyester. The choice of the textile is equally not critical, although it is logical to finish products which are in direct contact with the skin or which are generally intended to protect against insect bites, i.e. in particular underwear, shirts, slacks, T-shirts, uniforms, mosquito and camouflage nets.

Application Processes

A first suitable process for finishing fibers or textile fabrics is characterized in that the substrates are impregnated with water-containing combinations of microencapsulated active components and binders. Impregnation of the fibers or textiles may be carried out by the so-called exhaust method. This may be carried out in a commercially available washing machine or in a dyeing machine typically used in the textile industry.

Alternatively, the present invention also relates to a second process for finishing fibers and textile fabrics in which the microencapsulated active components and the binders are applied by pressure application. In this process, the fibers/fabrics to be treated are drawn through an immersion bath containing the microencapsulated active components and the binders, the preparations being applied under pressure in a press. This technique is known as padding

The concentration of active components is normally from 0.5 to 15 and preferably from 1 to 10% by weight, based on the liquor or the immersion bath. Impregnation generally requires lower concentrations than pressure application to charge the fibers or textile fabrics with the active components.

Finally, the present invention relates to the use of mixtures containing

(a) microencapsulated insect repellents and

(b) binders

for finishing fibers and textile fabrics.

### EXAMPLES

### Production Example H1

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 5 g permethrin, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 60° C. and added dropwise to a 0.5% by weight sodium alginate solution. An aqueous preparation containing 8% by weight of microcapsules with a mean diameter of 1 mm was obtained after sieving. Finally, the microcapsules were mixed with a polyurethane binder in a ratio by weight of 40:60, based on the solids content.

### Production Example H2

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 5 g DEET, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 50° C. and dispersed with vigorous stirring in 2.5 times the volume of paraffin oil cooled beforehand to 15° C. The dispersion was then washed with an aqueous solution containing 1% by weight sodium lauryl sulfate and 0.5% by weight sodium alginate and then repeatedly with a 0.5% by weight aqueous Phenonip solution, the oil phase being removed. An aqueous preparation containing 8% by weight of microcapsules with a mean diameter of 1 mm was obtained after sieving. Finally, the microcapsules were mixed with a polyurethane binder in a ratio by weight of 50:50, based on the solids content.

### Production Example H3

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 5 g Ethyl Butylacetylaminopropionate, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 60° C. and added dropwise to a 15% by weight solution of Sodium Laureth Sulfate. An aqueous preparation containing 9% by weight of microcapsules with a mean diameter of 1 mm was obtained after sieving. Finally, the microcapsules were mixed with a polyurethane binder in a ratio by weight of 50:50, based on the solids content.

### Production Example H4

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 5 g Hydroxyethyl Isobutyl Piperidine Carboxylate, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 60° C. and added dropwise to a 15% by weight solution of sodium pyrophosphate. An aqueous preparation containing 8% by weight of microcapsules with a mean diameter of 1 mm was obtained after sieving. Finally, the microcapsules were mixed with a polyurethane binder in a ratio by weight of 70:30, based on the solids content.

### Production Example H5

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 5 g deltamethrin, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 50° C. and dispersed with vigorous stirring in 2.5 times the volume of paraffin oil cooled beforehand to 15° C. The dispersion was then washed with a 15% by weight sodium pyrophosphate solution and then repeatedly with a 0.5% by weight aqueous Phenonip solution, the oil phase being removed. An aqueous preparation containing 10% by weight of microcapsules with a mean diameter of 1 mm was obtained after sieving. Finally, the microcapsules were mixed with a polyurethane binder in a ratio by weight of 70:30, based on the solids content.

### Production Example H6

In a 500 ml three-necked flask equipped with a stirrer and reflux condenser, 3 g gelatin were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 2.5 g permethrin, 2.5 g deltamethrin, 0.5 g Phenonip® in ad 100 g water were added to the mixture over a period of about 30 mins. with vigorous stirring. The matrix obtained was filtered, heated to 60° C. and added dropwise to a 0.5% by weight solution of Hydagen® SCD (succinylated chitosan, Cognis). An aqueous preparation containing 8% by weight of microcapsules with a mean diameter of 1 mm was obtained after sieving. Finally, the microcapsules were mixed with a polyurethane binder in a ratio by weight of 70:30, based on the solids content.

### Production Example H7

In a 500 ml three-necked flask equipped with a stirrer and reflux condenser, 3 g agar were dissolved in 200 ml water in boiling heat. First a homogeneous disperson of 10 g glycerol and 2 g talcum in ad 100 g water and then a preparation of 25 g chitosan (Hydagen® DCMF, 1% by weight in glycolic acid, Cognis, Düsseldorf/FRG), 4 g permethrin, 1 g Autan, 0.5 g Phenonip® (preservative mixture containing phenoxyethanol and parabens) and 0.5 g Polysorbate 20 (Tween® 20, ICI) in ad 100 g water were added to the mixture over a period of about 30 mins. with vigorous stirring. The matrix obtained was filtered, heated to 60° C. and added dropwise to a 0.5% by weight sodium alginate solution. To obtain microcapsules with the same diameter, the preparations were then sieved. Finally, the microcapsules were mixed with a polyurethane binder in a ratio by weight of 70:30, based on the solids content.

### Production Example H8

In a stirred vessel, 0.5 g preservative (Phenonip®) was dissolved in 50 g of a 2% by weight aqueous preparation of carboxymethyl cellulose and the solution was adjusted to pH 3.5. A mixture of 1 g deltamethrin and 0.5 sorbitan monostearate+20 EO (Eumulgin® SMS 20, Cognis Deutschland GmbH) was then added with vigorous stirring. A 1% by weight solution of chitosan in glycolic acid (Hydagen® DCMF, Cognis Deutschland GmbH) was then added with continued stirring in such a quantity that a chitosan concentration of 0.075% by weight, based on the preparation, was established. The pH was then raised to 5.5 by addition of triethanolamine and the microcapsules formed were decanted. Finally, the microcapsules were mixed with a polyurethane binder in a ratio by weight of 40:60, based on the solids content.

### Production Example H9

In a stirred vessel, 0.5 g preservative (Phenonip®) was dissolved in 50 g of a 2% by weight aqueous preparation of polyacrylic acid (Pemulen® TR-2), a pH of 3 being spontaneously established. A mixture of 1 g DEET, 0.5 g permethrin and 0.5 sorbitan monostearate+20 EO (Eumulgin® SMS 20, Cognis Deutschland GmbH) was then added with vigorous stirring. A 1% by weight solution of chitosan in glycolic acid (Hydagen® DCMF, Cognis Deutschland GmbH) was then added with continued stirring in such a quantity that a chitosan concentration of 0.01% by weight, based on the preparation, was established. The pH was then raised to 5.5 by addition of triethanolamine and the microcapsules formed were decanted. Finally, the microcapsules were mixed with a polyurethane binder in a ratio by weight of 40:60, based on the solids content.

### Production Example H10

In a stirred vessel, 0.5 g preservative (Phenonip®) was dissolved in 50 g of a 2% by weight aqueous preparation of polyacrylic acid (Pemulen® TR-2), a pH of 3 being spontaneously established. A mixture of 1 g deltamethrin and 0.5 g Coco Glucosides (Plantacare APG 1200, Cognis Deutschland GmbH) was then added with vigorous stirring. A 1% by weight solution of chitosan in glycolic acid (Hydagen® DCMF, Cognis Deutschland GmbH) was then added with continued stirring in such a quantity that a chitosan concentration of 0.01% by weight, based on the preparation, was established. The pH was then raised to 5.5 by addition of triethanolamine and the microcapsules formed were decanted. Finally, the microcapsules were mixed with a polyurethane binder in a ratio by weight of 40:60, based on the solids content.

Efficiency Tests

Knitted cotton fabrics in the form of shirt sleeves were finished with 6% by weight Skintex® MR III (basis: polyvinyl methylether/maleic anhydride copolymer corresponding to DE 3512565 A1, active component permethrin) in combination with 8% Cognis 3001-A and 0.3% Cognis 3002-A. The samples were worn 8 hours a day by 6 different volunteers and then washed. Every two hours, a selected area of the arm covered by the textile sample was exposed for 2 minutes to a population of around 100 blood-thirsty yellow fever mosquitoes (Aedes aegypti). The number of “long touch downs” and bites was recorded. A rate of less than 3 bites per 2 minutes was defined as an acceptable level of protection. If a volunteer was bitten three times in two successive test series, the test with Aedes was terminated and continued with the less aggressive species Culex quinquefasciatus. The tests were stopped when a volunteer was also bitten by Culex mosquitoes three times in two successive test series. The results are set out in Table 1 (A. aegypti) and as a continuation in Table 2 (C. quinquefasciatus):

TABLE 1
Efficiency tests with A. aegypti

Aedes aegypti

| Wearing time [h] | Wash cycles | Long touch downs | Bites |
|---|---|---|---|
| 0 | 0 | 8 | 2 |
| 2 | 0 | 12 | 3 |
| 4 | 0 | 18 | 2 |
| 6 | 0 | 19 | 1 |
| 8 | 0 | 10 | 2 |
| 8 | 1 | 18 | 1 |
| 10 | 1 | 18 | 2 |
| 12 | 1 | 16 | 2 |
| 14 | 1 | 18 | 2 |
| 16 | 1 | 8 | 1 |
| 16 | 2 | 22 | 2 |
| 18 | 2 | 20 | 3 |
| 20 | 2 | 24 | 2 |
| 22 | 2 | 21 | 2 |
| 24 | 2 | 16 | 2 |
| 26 | 2 | 26 | 3 |
| 26 | 3 | 25 | 3 |
| 28 | 3 | 15 | 3 |
| 30 | 3 | 18 | 2 |
| 32 | 3 | 23 | 3 |
| 34 | 3 | 14 | 3 |
| 34 | 4 | 29 | 3 |
| 36 | 4 | 21 | 3 |
| 38 | 4 | 25 | 3 |

TABLE 2
Efficiency tests with C. Quinquefasciatus

Culex quinquefasciatus

| Wearing time [h] | Wash cycles | Long touch downs | Bites |
|---|---|---|---|
| 40 | 4 | 32 | 1 |
| 42 | 4 | 29 | 1 |
| 44 | 4 | 21 | 1 |
| 44 | 5 | 27 | 2 |
| 46 | 5 | 32 | 1 |
| 48 | 5 | 63 | 2 |
| 50 | 5 | 53 | 2 |
| 52 | 5 | 45 | 2 |
| 52 | 6 | 35 | 3 |
| 54 | 6 | 50 | 2 |
| 56 | 6 | 48 | 3 |
| 58 | 6 | 48 | 3 |
| 60 | 6 | 43 | 3 |

The results show that, even under worst-case conditions, the fabrics finished in accordance with the invention afford adequate protection over a period of at least 5 days.

Washing Resistance

In order to test washing resistance, the following fabrics

blouse (68% cotton, 32% polyester)

white slacks (99% cotton, 1% Lycra)

colored shorts (97% cotton, 3% Lycra)

blue shorts (98% cotto, 2% Lycra)

colored Capri slacks (98% cotton, 2% Lycra)

were again finished with 6% by weight Skintex® MR III in combination with 8% Cognis 3001-A and 0.3% Cognis 3002-A and then machine-washed 25 times at 60° C. After each wash cycle, the fabrics were dried and the residual permethrin content was determined. For comparison, the same fabrics were impregnated with an emulsion containing non-encapsulated permethrin and subjected to the same test conditions. The average values of the results for the various textiles are set out in Table 3.

TABLE 3
Washing resistance

Residual permethrin content

| Wash cycles | Encapsulated | Non-encapsulated |
|---|---|---|
| 0 | 100 | 100 |
| 1 | 98 | 81 |
| 3 | 97 | 70 |
| 5 | 96 | 68 |
| 10 | 95 | 50 |
| 20 | 90 | 39 |
| 25 | 83 | 39 |

The results show that, even after 25 machine washes, the fabrics finished in accordance with the invention still contain more than 80% of the quantity of permethrin originally applied whereas the non-encapsulated permethrin content fell to below 40% under the same conditions.

1: Fibers and sheet-form textiles, finished with a mixture comprising:
(a) a microencapsulated insect repellent active component; and
(b) a binder.

2: Fibers and sheet-form textiles as claimed in claim 1, wherein, the insect repellent comprises a member selected from the group consisting of sesquiterpenes, diethyl toluamide (DEET), Ethyl Butylacetyl-aminopropionate (IR 3535), Hydroxyethyl isobutyl Piperidine Carboxylate, pyrethroids and mixtures thereof.

3: Fibers and sheet-form textiles as claimed in claim 2, wherein the insect repellent comprises a member selected from the group consisting of 5-benzyl-3-furylmethyl (+)-cis-(1R,3S,E) 2,2-dimethyl-3-(2-oxo-2,3,4,5-tetrahyfrothiophenylidenmethyl)cyclopropanecarboxylate, 6-chloropiperonyl 2,2-dimethyl-3-(2-methylpropenyl)cyclopropanecarboxylate, acrinathrin, allethrin, bifentrin, bioresmethrin, cismethrin, cyclethrin, cycloprothrin, cyfluthrin, cyhalothrin, cypermethrin, cyphenotrin, deltamethrin, dimethrin, empenthrin, esfenvalerat, fenfluthrin, fenpropathrin, fenvalerat, flucythrinat, flumethrin, fluvalinat, furethrin, halfenprox, imiprothrin, methyl cis/trans-3-(2,2-dichlorovinyl)-2,2-dimethylcyclopropane-1-carboxylate, permethrin and mixtures thereof.

4: Fibers and sheet-form textiles as claimed in claim 1, wherein, the microcapsules comprise an active-component content of 1 to 30% by weight.

5: Fibers and sheet-form textiles as claimed in claim 1, wherein, the mixture comprises microcapsules having a mean diameter of 0.0001 to 5 mm comprising a membrane and a matrix containing the active component produced by a process selected from the group consisting of
(a1) preparing a matrix comprising a gel former, chitosan and the active component,
(a2) optionally dispersing the matrix in an oil phase, and
(a3) treating the optionally dispersed matrix with an aqueous solution of anionic polymers and optionally removing the oil phase in the process;
(b1) preparing a matrix comprising a gel former, an anionic polymer and the active component,
(b2) optionally dispersing the matrix in an oil phase, and
(b3) treating the optionally dispersed matrix with an aqueous chitosan solution and optionally removing the oil phase in the process;
(c1) preparing a matrix comprising an anionic polymer and the active component,
(c2) dispersing the matrix in an oil phase, and
(c3) encapsulating the dispersed matrix with melamine/formaldehyde resins or maleic anhydride;
(d1) forming an O/W emulsion comprising the active component, an oil component, and an emulsifier,
(d2) treating the emulsion with an aqueous solution of an anionic polymer to form a matrix,
(d3) encapsulating the matrix by contact with an aqueous chitosan solution to form an encapsulated product and an aueous phase, and
(d4) recovering the encapsulated product from the aqueous phase; and
(e1) coating the active component alternately with layers of differently charged polyelectrolytes (layer-by-layer technique).

6: Fibers and sheet-form textiles as claimed in claim 1, containing microcapsules having a mean diameter of 0.001 to 0.5 mm.

7: Fibers and sheet-form textiles as claimed in claim 1, wherein, the binder comprises a member selected from the group consisting of polyurethane, polyethyl vinyl acetate, polymeric melamine compounds, polymeric glyoxal compounds, polymeric silicone compounds, epichlorohydrin-crosslinked polyamidoamines, poly(meth)acrylates, polymeric fluorocarbons, and mixtures thereof.

8: Fibers and sheet-form textiles as claimed in claim 1, finished with a mixture comprising microcapsules and binders in a ratio by weight of 90:10 to 10:90.

9: A method for imparting insect repellent properties to fibers and sheet-form textiles which comprises contacting the fibers and sheet-form textiles with a mixture comprising:
(a) a microencapsulated insect repellent active component and
(b) a binder.

10: The fibers and sheet-form textiles of claim 1 finished with a mixture, wherein, the microencapsulated active component has a mean particle size of from 0.001 to 0.05 mm.

11: The method of claim 9 wherein the binder expressed as active substance is applied to the fibers and textile fabric in an amount of from 0.5% to 15% by weight.

12: The fibers and sheet-form textiles as claimed in claim 2, wherein, the microcapsules comprise an active-component content of 1 to 30% by weight.

13: The fibers and sheet-form textiles as claimed in claim 3, wherein, the microcapsules comprise an active-component content of 1 to 30% by weight.

14: Fibers and sheet-form textiles as claimed in claim 2, wherein, the mixture comprises microcapsules having a mean diameter of 0.0001 to 5 mm comprising a membrane and a matrix containing the active component produced by a process selected from the group consisting of
(a1) preparing a matrix comprising a gel former, chitosan and the active component,
(a2) optionally dispersing the matrix in an oil phase, and
(a3) treating the optionally dispersed matrix with an aqueous solution of anionic polymers and optionally removing the oil phase in the process;
(b1) preparing a matrix comprising a gel former, an anionic polymer and the active component,
(b2) optionally dispersing the matrix in an oil phase, and
(b3) treating the optionally dispersed matrix with an aqueous chitosan solution and optionally removing the oil phase in the process;
(c1) preparing a matrix comprising an anionic polymer and the active component,
(c2) dispersing the matrix in an oil phase, and
(c3) encapsulating the dispersed matrix with melamine/formaldehyde resins or maleic anhydride;
(d1) forming an O/W emulsion comprising the active component, an oil component, and an emulsifier,
(d2) treating the emulsion with an aqueous solution of an anionic polymer to form a matrix,
(d3) encapsulating the matrix by contact with an aqueous chitosan solution to form an encapsulated product and an aqueous phase, and
(d4) recovering the encapsulated product from the aqueous phase; and
(e1) coating the active component alternately with layers of differently charged polyelectrolytes (layer-by-layer technique).

15: Fibers and sheet-form textiles as claimed in claim 2, containing microcapsules having a mean diameter of 0.001 to 0.5 mm.

16: Fibers and sheet-form textiles as claimed in claim 3, containing microcapsules having a mean diameter of 0.001 to 0.5 mm.

17: Fibers and sheet-form textiles as claimed in claim 2, wherein, the binder comprises a member selected from the group consisting of polyurethane, polyethyl vinyl acetate, polymeric melamine compounds, polymeric glyoxal compounds, polymeric silicone compounds, epichlorohydrin-crosslinked polyamidoamines, poly(meth)acrylates, polymeric fluorocarbons, and mixtures thereof.

18: Fibers and sheet-form textiles as claimed in claim 3, wherein, the binder comprises a member selected from the group consisting of polyurethane, polyethyl vinyl acetate, polymeric melamine compounds, polymeric glyoxal compounds, polymeric silicone compounds, epichlorohydrin-crosslinked polyamidoamines, poly(meth)acrylates, polymeric fluorocarbons, and mixtures thereof.

19: The fibers and sheet-form textiles of claim 2 finished with a mixture comprising microcapsules and binders in a ratio by weight of from 75:25 to 25:75.
